(19) United States
(12) Patent Application Publication
(10) Pub. No.: US 2005/0111386 A1
(43) Pub. Date: May 26, 2005

(54) Packing steiner trees

(76) Inventors: Kamal Jain, Bellevue, WA (US); Mohammad Mahdian, Cambridge, MA (US); Mohammad R. Salavatipour, Kitchener (CA)

Correspondence Address: LEE & HAYES PLLC, 421 W RIVERSIDE AVENUE SUITE 500, SPOKANE, WA, 99201, US

(21) Appl. No.: 10/719,182

(22) Filed: Nov. 20, 2003

(51) Int. Cl. H04L 12/28

(52) U.S. Cl. 370/256

(57) ABSTRACT

Systems and methods for packing Steiner trees are described. In one aspect, a set of Steiner trees and paths are generated from an undirected graph of vertices representing terminal and Steiner nodes. The Steiner trees and the paths are merged to produce linked and edge disjoint S-Steiner trees. If a subset S of the vertices is edge connected, then at minimum there are substantially α_{|S|}k edge-disjoint Steiner trees for S, wherein αₛ is a sequence that tends to an asymptotic approximation factor of |S|/4 as S tends to infinity.

The invention pertains to network data delivery.

### BACKGROUND

Multicast is packet communication between a single sender and multiple specific receivers on a network. A multicast route can be represented as a tree rooted at the sender with a receiver at each leaf, and possibly some receivers on internal nodes. Multicast service imposes specific requirements for network implementation. For instance, whenever a destination address of a data packet is a multicast address, the data packet must be routed from the sender to all targeted set of maximum size receivers. Instead of transmitting packets from a sender to each receiver separately, conventional multicast route identification techniques attempt to share links and minimize resource consumption to locate a tree that reaches all receivers. To deliver as many data streams to as possible to requesting customers, data broadcaster (sender) generally attempt to identify many such trees to the requesting clients.

Unfortunately, existing techniques to approximate edge-disjoint trees including as many edge-disjoint communication paths (as many as substantially possible) from a sender to requisite receiver nodes in networks that include sender(s), receiver(s), and router(s), generally do not produce a substantially optimal number of such trees as data senders generally desire. An edge-disjoint tree includes at least one edge disjoint path, wherein edge-disjoint means that the edges used in this tree are not used in the other trees. Instead, many such edge-disjoint trees/paths are overlooked. As a consequence, better techniques to approximate edge disjoint trees connecting senders to receivers in networks that include Steiner nodes, or routers, are desired. This would provide broadcasters with improved capability to distribute multiple disparate data streams, and offer receivers more viewing/listening choices.

### SUMMARY

Systems and methods for packing Steiner trees are described. In one aspect, a set of Steiner trees and paths are generated from an undirected graph of vertices representing terminal and Steiner nodes. The Steiner trees and the paths are merged to produce linked and edge disjoint S-Steiner trees. If a subset S of the vertices is edge connected, then at minimum there are substantially α_{|S|}k edge-disjoint Steiner trees for S, wherein αₛ, is a sequence that tends to an asymptotic approximation factor of |S|/4 as S tends to infinity.

### BRIEF DESCRIPTION OF THE DRAWINGS

In the figures, the left-most digit of a component reference number identifies the particular figure in which the component first appears.

FIG. 1 shows an exemplary computing environment within which systems and methods to pack Steiner trees may be implemented.

FIG. 2 shows further exemplary aspects of system memory of FIG. 1, including application programs and program data to locate a substantially maximum sized Steiner trees that can be used in many practical applications to connect to a same set of terminal vertices.

FIG. 3 shows an exemplary set of vertices of in input graph G. The exemplary vertices are used to demonstrate a shortcutting procedure that removes wasteful paths from a Steiner tree.

FIG. 4 shows a set of nodes (e.g., network nodes) for showing that there are a certain number of edge-disjoint S-Steiner trees in a graph as a function of a recurrence relation.

FIG. 5 shows an exemplary procedure to locate substantially maximum sized Steiner trees that can be used in many practical applications to connect to a same set of terminal vertices. In particular, FIG. 5 shows a procedure to produce linked and edge-disjoint S-Steiner trees for multicast of streaming media.

### DETAILED DESCRIPTION

Overview

From a theoretical perspective, techniques for finding Steiner trees connecting all senders and receivers (network terminals) are associated with fundamental theorems in combinatorics. At one extreme, when there are only two terminals, a Steiner tree is just a path between the terminals, which can be identified using the well-known Menger theorem. At the other extreme, when all the network vertices are terminals (i.e., only sender and receiver network nodes—no Steiner nodes, a Steiner tree is just a spanning tree of the graph, for which a solution is provided by the classical Nash-Williams-Tutte theorem. In this implementation, a Steiner node is a router, which is a device or, in some cases, software in a computer, that determines the next network point to which a packet should be forwarded toward its destination. The router is connected to at least two networks and decides which way to send each information packet based on its current understanding of the state of the networks to which it is connected. A router may be included as part of a network switch.

Theorem 1: Graph G(V,E) contains k edge-disjoint spanning trees if and only if:
E_{G}(P)≧k(t-1),
for every partition P={V₁, . . . ,V₁} of V into non-empty subsets, where E_{G}(P) denotes the number of edges between distinct classes of P. Since the problem of finding k disjoint spanning trees in a graph is a special case of finding k disjoint bases of a matroid, Theorem 1 can be derived from Edmonds' matroid partition theorem.

The Menger and the Nash-Williams-Tutte theorems are max-min theorems that can be generalized into a single theorem which says that the maximum number of edge-disjoint Steiner trees is the same as the integer part of the minimum value of

$$\frac{{E}_{G} ( P )}{\vert P \vert - 1} ,$$

where the minimum is over the set of all partitions of the vertices of graph that include at least one terminal in each class, with E_{G}(P) denoting the number of edges between distinct classes of P, and |P| denoting the number of classes of P. This statement is not true if we are not in the extreme cases described above (e.g., see Kriesell , reference [1]).

For instance, using Theorem 1, if a graph G is 2k -edge-connected then it has k edge-disjoint spanning trees. Kriesell [1] conjectured that this generalizes to Steiner trees, i.e., if a set S of vertices of G is 2k-edge-connected then there is a set of k edge-disjoint S-Steiner trees in G. This conjecture is still open, even with 2k replaced by any constant multiple of k. Notice that the edge-connectivity of the set S is an upper bound on the maximum number of edge-disjoint S-Steiner trees. Thus, a constructive proof for the above conjecture would provide a constant-factor approximation algorithm for the Steiner tree packing problem. This means that the algorithm produces a constant fraction of trees as would a substantially optimal algorithm.

The special case in which V−S is independent is considered by Kriesell [1] and Frank et al. [2]. A corollary of Theorem 1 is that for a graph G(V, E) and S⊂V , if V−S is an independent set and S is k(k+1)-edge-connected, then G contains k edge-disjoint S-Steiner trees. A stronger version of this appeared in [2], where they weaken the requirement for connectivity of S to 3k -edge-connectedness. This means that between any two nodes in S there are at least 3k-edge disjoint paths. They also prove a generalization of Theorem 1 to hypergraphs.

For an arbitrary set S, Petingi and Rodriguez [3] give a lower bound for the number of edge-disjoint S-Steiner trees, by showing that: if S is k-edge-connected in G and |S|≧2, then G has at least

$$⌊ {( \frac{2}{3} )}^{\vert V - S \vert} k / 2 ⌋$$

edge-disjoint S-Steiner trees. This means that their algorithm has performance guarantee of

$$⌊ {( \frac{2}{3} )}^{\vert V - S \vert} / 2 ⌋ .$$

This performance is very much worse, and in most practical cases amounts to triviality, than what is presented in the following detailed description.

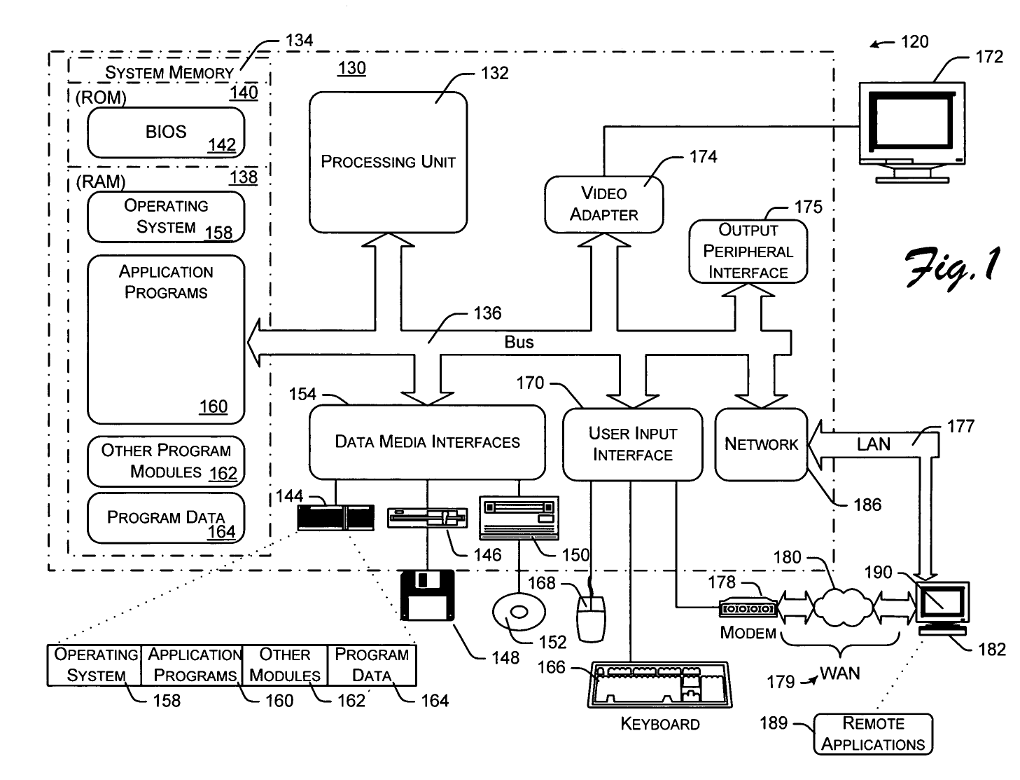

In contrast to existing techniques (e.g., as discussed by references [1] through [3]), systems and methods described below in reference to FIGS. 1-5, pack Steiner trees to approximate a substantially maximum number of edge-disjoint subgraphs of a given graph G that connect a given set of required points S. Distinct from conventional approaches to generating Steiner trees, systems and methods of the invention combine a collection of edge-disjoint paths with a collection of edge-disjoint Steiner trees by modifying the paths and trees in several (polynomial) iterations. This iterative process to modify the Steiner trees with edge-disjoint paths is termed Steiner tree packing. In particular, if a subset S in the graph is k-edge-connected, then there are α_{|S|}k edge-disjoint Steiner trees 206 for S, where αₛ is a sequence that tends to 4/s (an asymptotic approximation factor of |S|/4 ) as S tends to infinity.

The selected asymptotic approximation factor provides a sufficient condition for the existence of edge-disjoint Steiner trees in a graph in terms of the edge-connectivity of the graph. This condition is substantially optimal when S consists of three (3) points—sender and receiver nodes.

These and other aspects of the systems and methods to pack Steiner trees are now described in further detail.

Exemplary Operating Environment

Turning to the drawings, wherein like reference numerals refer to like elements, the invention is illustrated as being implemented in a suitable computing environment. Although not required, the invention is described in the general context of computer-executable instructions, such as program modules, being executed by a personal computer. Program modules generally include routines, programs, objects, components, data structures, etc., that perform particular tasks or implement particular abstract data types.

FIG. 1 illustrates an example of a suitable computing environment 120 on which the subsequently described systems, apparatuses and methods to pack Steiner trees for multicast of streaming media may be implemented. Exemplary computing environment 120 is only one example of a suitable computing environment and is not intended to suggest any limitation as to the scope of use or functionality of systems and methods the described herein. Neither should computing environment 120 be interpreted as having any dependency or requirement relating to any one or combination of components illustrated in computing environment 120.

The methods and systems described herein are operational with numerous other general purpose or special purpose computing system environments or configurations. Examples of well-known computing systems, environments, and/or configurations that may be suitable include, but are not limited to, including small form factor (e.g., hand-held, mobile, etc.) computing devices (e.g., mobile phones, personal digital assistants—PDAs, etc.), multi-processor systems, microprocessor based or programmable consumer electronics, network PCs, minicomputers, mainframe computers, and/or so on. The invention is also practiced in distributed computing environments where tasks are performed by remote processing devices that are linked through a communications network. In a distributed computing environment, program modules may be located in both local and remote memory storage devices.

As shown in FIG. 1, computing environment 120 includes a general-purpose computing device in the form of a computer 130. The components of computer 130 may include one or more processors or processing units 132, a system memory 134, and a bus 136 that couples various system components including system memory 134 to processor 132. Bus 136 represents one or more of any of several types of bus structures, including a memory bus or memory controller, a peripheral bus, an accelerated graphics port, and a processor or local bus using any of a variety of bus architectures. By way of example, and not limitation, such bus architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus also known as Mezzanine bus.

Computer 130 typically includes a variety of computer readable media. Such media may be any available media that is accessible by computer 130, and it includes both volatile and non-volatile media, removable and non-removable media. System memory 134 includes computer readable media in the form of volatile memory, such as random access memory (RAM) 138, and/or non-volatile memory, such as read only memory (ROM) 140. A basic input/output system (BIOS) 142, containing the basic routines that help to transfer information between elements within computer 130, such as during start-up, is stored in ROM 140. RAM 138 typically contains data and/or program modules that are immediately accessible to and/or presently being operated on by processor 132.

Computer 130 may further include other removable/non-removable, volatile/non-volatile computer storage media. For example, a hard disk drive 144 may be used for reading from and writing to a non-removable, non-volatile magnetic media (not shown), a magnetic disk drive 146 for reading from and writing to a removable, non-volatile magnetic disk 148 (e.g., a “floppy disk”), and an optical disk drive 150 for reading from or writing to a removable, non-volatile optical disk 152 such as a CD-ROM/R/RW, DVD-ROM/R/RW/+R/RAM or other optical media. Hard disk drive 144, magnetic disk drive 146 and optical disk drive 150 are each connected to bus 136 by one or more interfaces 154.

The drives and associated computer-readable media provide nonvolatile storage of computer readable instructions, data structures, program modules, and other data for computer 130. Although the exemplary environment described herein employs a hard disk, a removable magnetic disk 148 and a removable optical disk 152, it are appreciated by those skilled in the art that other types of computer readable media which can store data that is accessible by a computer, such as magnetic cassettes, flash memory cards, digital video disks, random access memories (RAMs), read only memories (ROM), and the like, may also be used in the exemplary operating environment.

A number of program modules may be stored on the hard disk, magnetic disk 148, optical disk 152, ROM 140, or RAM 138, including, e.g., an operating system 158, one or more application programs 160 to pack Steiner trees for multicast of streaming media, other program modules 162, and associated program data 164.

A user may provide commands and information into computer 130 through input devices such as keyboard 166 and pointing device 168 (such as a “mouse”). Other input devices (not shown) may include a microphone, joystick, game pad, satellite dish, serial port, scanner, digital camera, etc. These and other input devices are connected to the processing unit 132 through a user input interface 170 that is coupled to bus 136, but may be connected by other interface and bus structures, such as a parallel port, game port, or a universal serial bus (USB).

A monitor 172 or other type of display device is also connected to bus 136 via an interface, such as a video adapter 174. The monitor can be utilized, for example, to present a user interface (UI) associated with the described systems and methods to pack Steiner trees for multicast of streaming media. In addition to monitor 172, personal computers typically include other peripheral output devices (not shown), such as speakers and printers, which may be connected through output peripheral interface 175.

Computer 130 may operate in a networked environment using logical connections to one or more remote computers, such as a remote computer 182. In such an implementation, the computer 130 may be a data receiver and/or a data sender network node. Remote computer 182 may include some or all of the elements and features described herein relative to computer 130. Logical connections include, for example, a local area network (LAN) 177 and a general wide area network (WAN) 179. Such networking environments are commonplace in offices, enterprise-wide computer networks, intranets, and the Internet.

When used in a LAN networking environment, computer 130 is connected to LAN 177 via network interface or adapter 186. When used in a WAN networking environment, the computer typically includes a modem 178 or other means for establishing communications over WAN 179. Modem 178, which may be internal or external, may be connected to system bus 136 via the user input interface 170 or other appropriate mechanism.

Depicted in FIG. 1, is a specific implementation of a WAN via the Internet. Here, computer 130 employs modem 178 to establish communications with at least one remote computer 182 via the Internet 180. In a networked environment, program modules depicted relative to computer 130, or portions thereof, may be stored in a remote memory storage device. Thus, e.g., as depicted in FIG. 1, remote application programs 189 may reside on a memory device of remote computer 182. The network connections shown and described are exemplary. Thus, other means of establishing a communications link between the computing devices may be used.

Exemplary Application Programs and Data

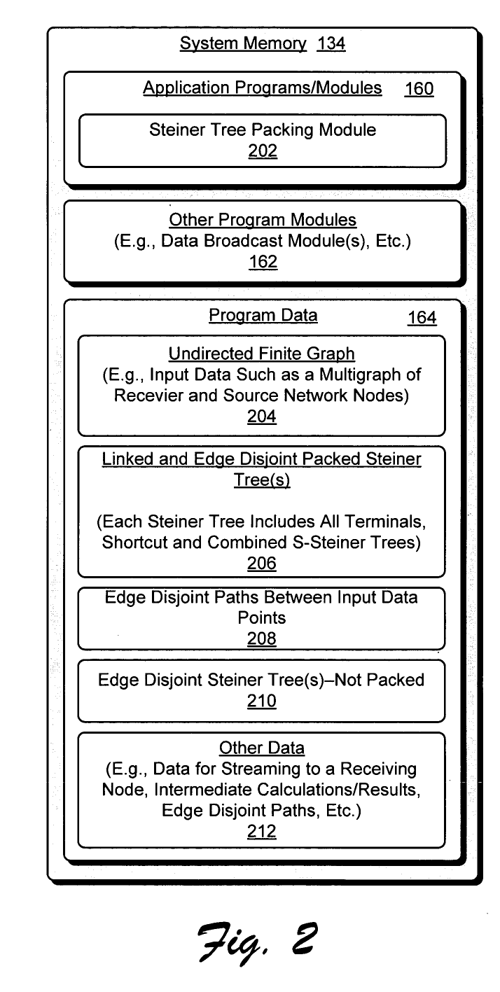

FIG. 2 is a block diagram that shows further exemplary aspects of system memory 134 of FIG. 1, including application programs 160 and program data 164 to locate a substantially maximum number of linked and edge-disjoint Steiner trees that can be used in many practical applications to connect in different ways to a same set of terminal vertices. The definition of a terminal vertex is implementation dependent. For instance, in a networking scenario, terminal vertices include sender and receiver network nodes. In its full generality, the Steiner tree packing module 202 has many practical applications such as in data broadcasting, VLSI circuit design, etc, as described in greater detail below in the section titled “An Exemplary Procedure”.

Application programs 160 include, for example, Steiner tree packing module 202 to analyze an undirected finite graph (“G”) 204 of vertices (input data) to produce a substantially maximum number of linked, edge-disjoint, and packed (“LED&P”) Steiner tree(s) 206 to approximate a substantially maximum number of edge-disjoint subgraphs (S-Steiner trees) of the given graph G that connect a given set of requisite points S.

Points S are implementation dependent. For instance, in a computer data server networking application, the data server may have some number of requesting receiver network nodes to which the server is to multicast streaming data. In this networking example, the required points S are requesting receiver network nodes. In yet another example, the terminal vertices may be elements on a circuit for the exchange of electrical signals. These are only a couple of examples of different applications and possible definitions of a data point/element of S.

To generate the LED&P Steiner nodes 206, the Steiner tree packing module 202 generates a collection of paths 208 and edge-disjoint Steiner trees 210 by modifying paths between graph data points and Steiner trees in several (polynomial) iterations. If a subset S in the graph is k-edge-connected, there are α_{|S|}k edge-disjoint Steiner trees 206 for S, where αₛ is a sequence that tends to

$$\frac{4}{s}$$

(an asymptotic approximation factor of |S|/4) as S tends to infinity. This iterative process, generates, removes shared edges (i.e., shortcuts), and merges the edge disjoint S-Steiner trees 210.

### Preliminaries

A path between two vertices u and v in a graph G (i.e., undirected graph 204) is a sequence u=v₀,e₁,v₁,e₂,v₂, . . . ,eₖ, vₖ=v such that eᵢ's are distinct edges of G, and the endpoints of eᵢ are vᵢ₋₁ and vᵢ. Such a path is called simple if vᵢ's are all distinct. The edge-connectivity of a connected graph G is the minimum number k of edges required to remove from G to make it disconnected. Let G(V,E) be a graph 204 and S⊂V be a set of at least two vertices of G. For purposes of discussion, S is shown as a respective portion of “other data” 212. We say that S is k-edge-connected in G if for any set F of less than k edges in G, there is a path between any pair of vertices in S in G\F. In other words, the S-edge-connectivity of G is the minimum number of edges whose removal disconnects at least two vertices of S.

For a graph G(V,E) 204, and a set S⊂V of at least two vertices, an S-Steiner tree 210 is a subgraph T(V′,E′) of G; T(V′,E′) is a tree and S⊂V′. The Steiner tree packing problem for a given graph G(V,E) 204 and S⊂V is solved by the Steiner tree packing module 202, which finds a set of maximum size of edge-disjoint S-Steiner trees 210 of G 204 and combines them to generate the linked and disjoint packed (LED&P) Steiner trees 206, as now described.

### Steiner Tree Packing

For a graph G(V,E) and S⊂V with |S|=s (e.g., undirected graph 204), if S is k-edge-connected, then there are αₛk linked and edge-disjoint Steiner trees 206 for S, where αₛ is a sequence that is asymptotic to 4/s as s tends to infinity (s tends to infinity is S). For simplicity of exposition, we first prove the following theorem, whose proof contains information that is later used to prove the immediately above.

Theorem 2: Let G(V,E) be a graph 204 and S={v₁,v₂,v₃} be a subset of V. Assume that v₁ and v₂ are k-edge-connected, and v₁ and v₃ are

$$\frac{k}{s} -$$

edge-connected in G. Then G has

$$\frac{k}{s}$$

edge-disjoint S-Steiner trees 210.

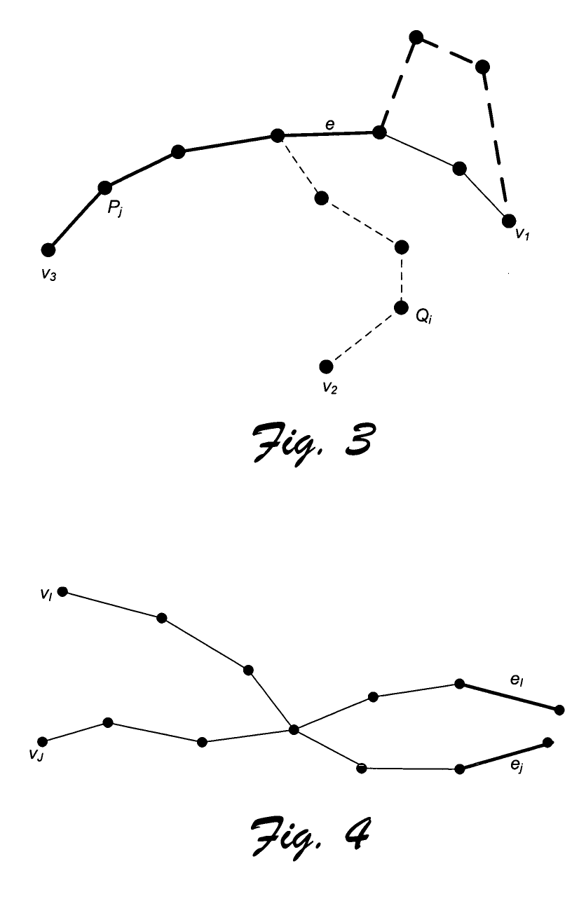

FIG. 3 shows an exemplary set of vertices of an input graph G 204. The exemplary vertices are used to demonstrate a shortcutting procedure to remove wasteful paths P from a Steiner tree, and thereby generate one or more edge-disjoint S-Steiner tree(s) 210. Referring to FIG. 3, the Proof of Theorem 2 follows.

Proof. Let

$$P = \{ {P}_{1} , {P}_{2} , … , {P}_{\frac{k}{2}} \}$$

be a set of k/2 edge-disjoint paths 208 between v₁ and v₃. Similarly, let Q={Q₁,Q₂, . . . , Qₖ} be a set of k paths 208 between v₁ and v₂. We consider the paths of P from v₃ to v₁; thus, an edge e appears before another edge e′ on Pᵢ if e is closer to v₃ than e′ on Pᵢ. Similarly, we consider the paths of Q from v₂ to v₁. Note that the paths in P are not necessarily disjoint from the paths in Q. The last intersection of a path Qᵢ with P is the last edge (i.e., the edge closest to v₁) on Qᵢ that is also part of a path in P. Assume that there exists a path Qᵢ∈Q whose last intersection with P is e∈Pⱼ and e is not the last edge of Pⱼ. Such a situation is called a wasteful situation, which may be removed via shortcutting operations.

### The Shortcutting Process

A shortcutting procedure removes wasteful situations. For instance, and with respect to the immediately preceding example, a new path Pⱼ* is constructed by replacing the part of Pⱼ after e with the part of Qᵢ after e. Notice that depending on whether e is traversed by Pⱼ and Qᵢ in the same or opposite directions, e in Pⱼ* will or will not be included (Pⱼ* of FIG. 3 is marked with thick pixel lines as compared to the pixel thickness of other lines in the figure). Note that e is the last intersection of Qᵢ with P, therefore Pⱼ* does not intersect any path in P\Pⱼ. At this point, the shortcutting operation removes the shortcut path. In this example, Pⱼ is removed from P and Pⱼ* is added to the LED&P Steiner tree 206. After doing this, P is still a set of k/2 edge-disjoint paths from v₃ to v₁. We call this a shortcutting of Pⱼ on Qᵢ, and say that Qᵢ is that path that is used for shortcutting Pⱼ*.

The shortcutting procedure is repeated as long as a wasteful situation is present in a Steiner tree that to generate an edge-disjoint Steiner tree 210 (path-tree). Let Q* denote the set of paths in Q that are used for shortcutting a path in P (Q* changes for each iteration of the algorithm). At any time, each path in P can be shortcut through at most one path in Q. Therefore, if Pⱼ is first shortcut through Qᵢ (i.e., it is replaced by the path Pⱼ* constructed above) and at a later iteration, Pⱼ* is shortcut through Q_{i′}, then at this iteration the shortcutting operation removes i from Q* and add i′ instead. Let T denote the number of pairs (i, j) such that Pⱼ∈P and Qᵢ∈Q intersect (T changes in each iteration of the algorithm).

In view of the above, the shortcutting procedure never increases the value of T. Additionally, each shortcutting iteration either increases the number paths in Q*, or decreases T. Accordingly, it follows that the shortcutting operations eventually stop in a non-wasteful situation. In such a situation, every path Qᵢ∈Q that has a non-empty intersection with P is used for shortcutting one path in P (i.e., belongs to Q*). Therefore, the number of paths in Q that have an intersection with a path in P is not more than k/2. So if all edges of the paths in P from G are removed, there are still

$$\frac{k}{2}$$

edge-disjoint paths from v₁ to v₂. Each such path together with a path from P forms an S-Steiner tree.

By induction on S and using the shortcutting procedure, for a graph G(V,E) and S⊂V where S={v₁,v₂, . . . , vₛ}, if v₁ and vᵢ are (i−1)k-edge-connected in G, for 2≦i≦s, then there are k edge-disjoint S-Steiner trees 206 in G. The existence of the same number of edge-disjoint S-Steiner trees 206 is substantially guaranteed under assumption that S is (s−1)k-edge-connected, using the following simple argument: add a new vertex u and connect it to each of v₂,v₃ . . . , vₛ with k parallel edges. In this graph, u and v₁ are (s−1)k-edge-connected and therefore, by Menger's theorem, there are (s−1)k edge-disjoint paths 208 from u to v₁. These paths can be partitioned into s−1 groups, such that the ith group consists of k paths between vᵢ₊₁ and v₁. These paths are combined to obtain k edge-disjoint S-Steiner trees 206 in G.

These results substantially guarantee the existence of a collection of LED&P Steiner trees 206 all of which are stars. A star means that the sender is at the center and has edge disjoint paths going to all receivers.

Theorem 3: Let G(V,E) be a graph 204 and S be a subset of s vertices of G. If S is k-edge-connected in G, then there are └αₛk┘ edge-disjoint S-Steiner trees in G 204, where αᵢ is defined by the following recurrence relation.
α₂=1 ∀>2, αᵢ=αᵢ₋₁−αᵢ₋₁²/4 (1).
Theorem 3 can be used to identity a better bound based on the proof of Theorem 2.

ProofSketch: Induction on s is utilized. If s=2, the theorem derives from Menger's theorem. Suppose s>2, and let v₁,v₂, . . . ,vₛ be the vertices in S. Define S′:=S\{vₛ}. By induction hypothesis, there is a collection T of αₛ₋₁k edge-disjoint S′-Steiner trees 210 in G 204. We denote these Steiner trees by T₁, . . . ,T_{α}_{_{s−1}}k. Also, from Menger's theorem, we know there are k edge-disjoint paths P₁,P₂, . . . ,Pₖ 210 between vₛ and v₁. We consider these paths 210 as paths starting from vₛ. So, we say an edge e appears before (after) e′ in Pⱼ if e is closer (farther) to vₛ than e′.

The basic idea is to combine these trees and paths to obtain LED&P Steiner trees 206 for S. A challenge arises when trees and paths have some edges in common (shared edge(s)). For purposes of discussion, an edge e is called a red edge if it is both in a tree Tᵢ and a path Pⱼ. Consider a tree, say T₁. For each required point v₁, 1≦i≦s−1, find the closest red edge to vᵢ in T₁. Let e be a red edge in T₁, i.e., e is in T₁∩Pⱼ for some path Pⱼ. If e is the closest red edge to several vertices vᵢ_{₁},vᵢ_{₂}, . . . ,vᵢ_{ₜ} in T₁, then we “shortcut” the path Pⱼ to vᵢ_{₁},vᵢ_{₂}, . . . ,vᵢ_{ₜ} at e. That is, we remove the part of Pⱼ after e, and add to it the paths in T₁ between e and vᵢ_{₁}, vᵢ_{₂}, . . . ,vᵢ_{ₜ}. Notice that after this operation, Pⱼ is no longer a path; it starts from vₛ as a path, but after reaching e it branches into several branches each ending in one of Vᵢ_{ᵣ}'s. We call such a structure a path-tree, as we want to emphasize the distinction between the part between vₛ and e (which comes from the original path Pⱼ), and the part after e (that comes from the tree T₁).

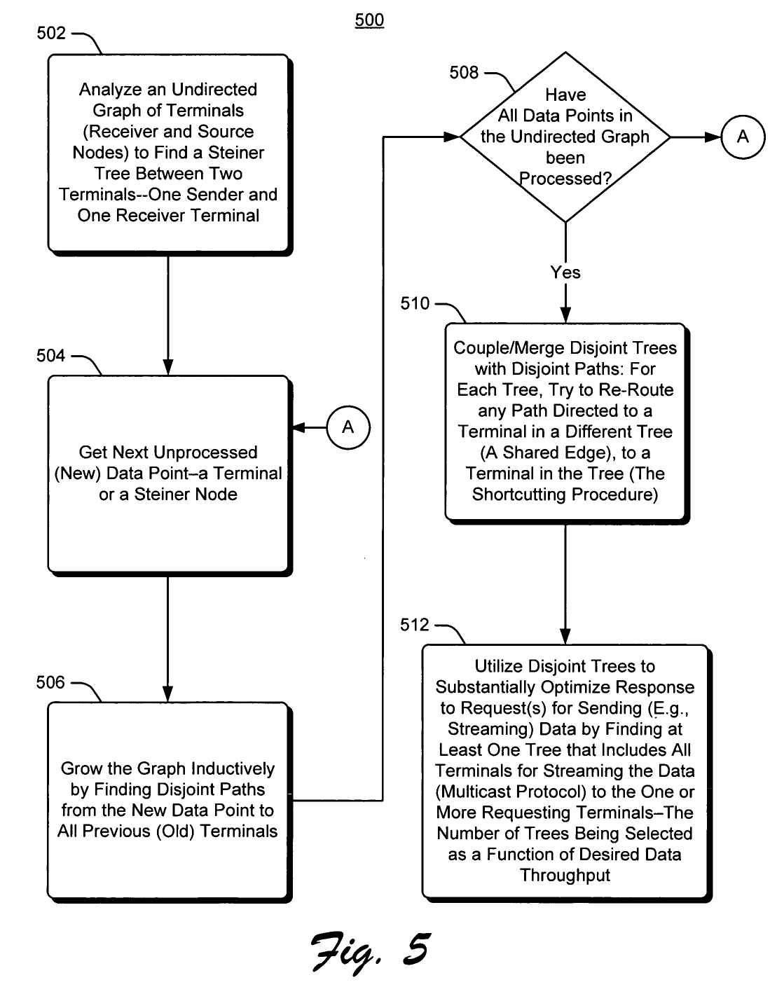

FIG. 4 shows a set of nodes (e.g., network nodes) for showing the Proof of Theorem 3, which shows that there are a certain number of edge-disjoint S-Steiner trees in a graph as a function of a recurrence relation. Referring to FIG. 4, the collection of Pⱼ's after the above shortcutting procedure are assumed to be edge-disjoint, since an intersection between Pⱼ's can occur after the above procedure only if the paths between two required points vᵢ and vⱼ and their respective closest red edges eᵢ and eⱼ intersect, and in such a situation we can pick eᵢ as the closest red edge to both vᵢ and vⱼ

After all paths that intersect T₁ in a red edge that is the closest red edge to one of vᵢ's are shortcut, the same shortcutting procedure is performed for for T₂. However, if a path Pⱼ is shortcut at e while processing T₁, the edges of Pⱼ that are discarded in this process (i.e., edges that come after e in Pⱼ), are no longer considered red edges. We perform the shortcutting procedure on all trees T₁, . . . ,T_{α}_{_{s−1}}k. For purposes of discussion, trees T₁, . . . ,T_{α}_{_{s−1}}k prior to being shortcut, are represented as S-Steiner trees 208.

After this process, paths may have been shortcut twice. For example, Pⱼ might be shortcut at an edge e while processing T₁, and at an edge e′ before e while processing T₂. If this happens, the edges of the part of Pⱼ that is discarded during the shortcutting procedure for T₂ (i.e., the edges that come after e′) are marked as non-red edges (so e is no longer a red edge), and the shortcutting procedure is again performed for T₁. That is, each of the vertices vᵢ_{₁}, vᵢ_{₂}, . . . ,vᵢ_{ₜ} that had e as their closest red edge in T₁ previously will have to choose their closest red edge again, with the updated set of red edges. This procedure iterates until every Pⱼ is shortcut for at most one tree. It is apparent that this procedure ends, since every iteration discards some edges that were originally in Pⱼ.

At this point, each Pⱼ is shortcut for at most one tree Tᵢ. Let Qₛ denote the collection of Pⱼ's that are not shortcut (and therefore are still paths from vₛ to v₁), let f denote the size of Qₛ. Also, let xᵢ (i=0, . . . ,s−1) denote the number of Tⱼ's that are used for shortcutting exactly i paths. For i>0, from these trees and the paths that are shortcut through them, we get a collection of ixᵢ path-trees, that we denote by Q₁. We let Q₀ denote the collection of x₀ Steiner trees that are not used in shortcutting any path (ixᵢ path-trees and x₀ Steiner trees are represented as respective ones of the Edge-Disjoint S-Steiner trees 210).

From the above definitions, since there are k−f of Pⱼ's that are shortcut exactly once in the above procedure, we have

$${\sum }_{i = 0}^{s - 1} {ix}_{i} = k - f .$$

For simplicity, we let xₛ:=f/s . Therefore, the above equation is written as

$${\sum }_{i = 0}^{s} {ix}_{i} = k . \qquad ( 2 ) .$$

Also, since each of the Tⱼ's is counted in exactly one of xᵢ's, we have

$${\sum }_{i = 0}^{s - 1} {x}_{i} = {α}_{s - 1} k . \qquad ( 3 )$$

The collection of all k paths and path-trees in Q₁∪. . . ∪Qₛ and x₀ trees in Q₀ constitute a collection Q of k+x₀ edge-disjoint subgraphs (S-Steiner trees) 210 of G 204. In the rest of the proof, the subgraphs in Q are combined (merged) to construct LED&P S-Steiner trees 206 in G.

Let p be a number such that Σᵢ₌ₚ₊₁^{s}ixᵢ<x₀≦Σᵢ₌ₚ^{s}ixᵢ. If x₀≧sxₛ, we define p=s, and if Σᵢ₌₁^{s}ixᵢ<x₀, we define p=0. For every i=p+1, . . . ,s−1, from each of the ixᵢ path-trees in Qᵢ, we pick one path from vₛ to one of v₁, . . . ,vₛ₋₁. Also, Qₛ is by itself a collection of sxₛ paths from vₛ to v₁. Thus, we can obtain Σᵢ₌ₚ₊₁^{s}ixᵢ edge-disjoint paths from vₛ to one of v₁, . . . ,vₛ₋₁, from Qₚ₊₁∪. . . ∪Qₛ. There are pxₚ path-trees in Qₚ, corresponding to xₚ trees in T. Consider the path-trees corresponding to ┌(x₀−Σᵢ₌ₚ₊₁^{s}ixᵢ)/p┐ of these trees, and from each of these ┌(x₀−Σᵢ₌ₚ₊₁^{s}ixᵢ)/p┐ path-trees, take one path from vₛ to one of v₁, . . . ,vₛ₋₁. This gives us a collection of ┌(x₀−Σᵢ₌ₚ₊₁^{s}ixᵢ)/p┐≧x₀−Σᵢ₌ₚ₊₁^{s}ixⱼ paths from vₛ to one of v₁, . . . ,vₛ₋₁. Therefore, we get at least x₀ edge-disjoint paths from vₛ to one of v₁, . . . ,vₛ₋₁ at the expense of destroying the path-trees in Qₛ,Qₛ₋₁, . . . ,Qₚ₊₁, and the path-trees in Qₚ corresponding to ┌(x₀−Σᵢ₌ₚ₊₁^{s}ixᵢ)/p┐ trees in T. Each of these paths can be joined with one of the trees in Q₀ to form a LED&P S-Steiner tree 206. The remaining pxₚ−┌(x₀−Σᵢ₌ₚ₊₁^{s}ixᵢ)/p┐ path-trees in Qₚ can be grouped into xₚ−┌(x₀−Σᵢ₌ₚ₊₁^{s}ixᵢ)/p┐ groups, each group consisting of p path-trees that correspond to the same tree in T. The union of the path-trees in each group is a graph that connects all vertices in S, and therefore contains an S-Steiner tree. This gives us xₚ−┌(x₀−Σᵢ₌ₚ₊₁^{s}ixᵢ)/p┐ S-Steiner trees. Similarly, from each Qᵢ, i=p, p−1, . . . , 1, we get xᵢ S-Steiner trees. Therefore, the total number of LED&P S-Steiner trees 206 that we obtain is equal to

$$\begin{matrix}{SOL}_{p} ( x ) = {x}_{0} + {x}_{p} - ⌈ ( {x}_{0} - {\sum }_{i = p + 1}^{s} {ix}_{i} ) / p ⌉ + {\sum }_{i = 1}^{p - 1} {x}_{i} \\ = ⌊ \frac{p - 1}{p} {x}_{0} + {\sum }_{i = 1}^{p - 1} {x}_{i} + {\sum }_{i = p + 1}^{s} {x}_{i} ⌋ .\end{matrix} \qquad ( 4 )$$

(Elements of SOLp(x) represents the worst case situation).

Here two special cases p 32 0 and p=s are considered. Using the same method, one can see that in these two cases SOL₀(x)=Σᵢ₌₁^{s}ixᵢ and SOLₛ(x)=Σᵢ₌₀^{s-1}xᵢ S-Steiner trees, respectively, are produced. By Equations (2) and (3), we have SOL₀(x)=k and SOLₛ(x)=αₛ₋₁k. Therefore, in these cases we get at least αₛ₋₁k>αₛk edge-disjoint S-Steiner trees 206. Thus, we may assume without loss of generality that 1≦p<s.

Now that we have computed the number of S-Steiner trees 206 produced in terms of xᵢ's, worst-case behavior is analyzed by treating xᵢ's as variables and solving the following linear program.

$$minimize \frac{p - 1}{p} {x}_{0} + {\sum }_{i = 1}^{p - 1} {x}_{i} + {\sum }_{i = p + 1}^{s} \frac{i}{p} {x}_{i}$$

$$subject to {\sum }_{i = 0}^{s} {ix}_{i} = k \\ {\sum }_{i = 0}^{s - 1} {x}_{i} = {α}_{s - 1} k \\ ∀ i \text{:} {x}_{i} \geq 0. \qquad ( 5 )$$

To upper bound the solution of the above linear program, we multiply its first constraint by 1/p² and its second constraint by (p−1)/p. We obtain the following.

$${\sum }_{i = 0}^{s - 1} ( \frac{p - 1}{p} + \frac{i}{{p}^{2}} ) {x}_{i} + \frac{s}{{p}^{2}} {x}_{s} = ( \frac{1}{{p}^{2}} + \frac{p - 1}{p} {α}_{s - 1} ) k . \qquad ( 6 )$$

In view of this, one can see that for i≦p,

$$\frac{p - 1}{p} + \frac{i}{{p}^{2}} \leq 1 and for i > p , \frac{p - 1}{p} + \frac{i}{{p}^{2}} < \frac{i}{p} .$$

Also,

$$\frac{s}{{p}^{2}} < \frac{s}{p} .$$

Thus, since xᵢ≧0 for every i,

$$\frac{p - 1}{p} {x}_{0} + {\sum }_{i = 1}^{p} {x}_{i} + {\sum }_{i = p + 1}^{s} \frac{i}{p} {x}_{i} \geq {\sum }_{i = 0}^{s - 1} ( \frac{p - 1}{p} + \frac{i}{{p}^{2}} ) {x}_{i} + \frac{s}{{p}^{2}} {x}_{s} = ( \frac{1}{{p}^{2}} + \frac{p - 1}{p} {α}_{s - 1} ) k . \qquad ( 7 )$$

Equation (7) shows that in the worst case the Steiner tree packing module 202 of FIG. 2 finds at least

$$⌊ ( \frac{1}{{p}^{2}} + \frac{p - 1}{p} {α}_{s - 1} ) k ⌋$$

edge-disjoint S-Steiner trees 206. The minimum of this expression is at p=2/αₛ₋₁. Thus, the Steiner tree packing module 202 finds at least └(αₛ₋₁−αₛ₋₁²/ 4)k┘=└αₛk edge-disjoint S-Steiner trees 206.

The algorithm given in the proof of Theorem 3 can be implemented in polynomial time. Polynomial time means that a run of the algorithm takes a small number of steps bounded above by a polynomial function of the graph size. Since the edge-connectivity of the set S is an upper bound on the maximum number of edge-disjoint S-Steiner 206 that can be packed in G, we arrive at the following:

Corollary 1: There is a polynomial time algorithm for the Steiner tree packing problem with an approximation ratio of αₛ, where s is the number of required points.

Lemma 1: Let αₙ be the sequence defined by Equation (1), the reoccurrence relation. Then

$${α}_{n} = \frac{4}{n} + o ( \frac{1}{n} ) .$$

Proof. Let

$${β}_{n} = \frac{1}{2} - \frac{{α}_{n}}{4} ,$$

for n≧2. Therefore, from Equation (1) we have:

$${β}_{n} = {β}_{n - 1}^{2} + \frac{1}{4} . \qquad ( 8 )$$

Assertion 1: For n≧2,

$${β}_{n} \geq \frac{1}{2} - \frac{1}{n} .$$

Proof. Induction is used on n. The statement holds trivially for n=2. Suppose n>2 and the claim is true for all values up to n−1. By Equation (8):

$$\begin{matrix}{β}_{n} \geq {( \frac{1}{2} - \frac{1}{( n - 1 )} )}^{2} + \frac{1}{4} \\ = \frac{1}{2} - \frac{n - 2}{{( n - 1 )}^{2}} \\ \geq \frac{1}{2} - \frac{1}{n} .\end{matrix}$$

Assertion 2: For n≧2,

$${β}_{n} \leq \frac{1}{2} - \frac{1}{4 n} .$$

Proof. again, we use induction on n. The base case n=2 is trivially true. Suppose the statement holds for all values up to n−1. By (8) and the induction hypothesis,

$$\begin{matrix}{β}_{n} \leq {( \frac{1}{2} - \frac{1}{4 ( n - 1 )} )}^{2} + \frac{1}{4} = \frac{1}{2} - \frac{4 n - 5}{16 {( n - 1 )}^{2}} \\ = \frac{1}{2} - \frac{4 {n}^{2} - 5 n}{16 {n ( n - 1 )}^{2}} \leq \frac{1}{2} - \frac{4 {n}^{2} - 8 n + 4}{16 {n ( n - 1 )}^{2}} \\ = \frac{1}{2} - \frac{1}{4 n} .\end{matrix}$$

This assertion is used to prove the following stronger statement/assertion.

Assertion 3: There is a constant c such that

$${β}_{n} \leq \frac{1}{2} - \frac{1}{n} + \frac{c}{n l n n} .$$

Proof. For small values of n, the claim is true if we let c to be a large enough constant. Let's assume the n is sufficiently large and that the claim is true for all intergers up to n−1. From Equation (8) we have

$$\begin{matrix}{β}_{n} \leq {( \frac{1}{2} - \frac{ln ( n - 1 ) - c}{( n - 1 ) ln ( n - 1 )} )}^{2} + \frac{1}{4} \\ = \frac{1}{2} - \frac{( ln ( n - 1 ) - c ) [ ( n - 2 ) ln ( n - 1 ) + c ]}{{( n - 1 )}^{2} {ln}^{2} ( n - 1 )} .\end{matrix}$$

So, to prove the assertion, it is enough to show that,

$$\begin{matrix}\frac{( ln ( n - 1 ) - c ) [ ( n - 2 ) ln ( n - 1 ) + c ]}{{( n - 1 )}^{2} {ln}^{2} ( n - 1 )} \geq \frac{ln n - c}{n ln n} , & ( 9 ) \\ or equivalently , & \\ n ln n ( ln ( n - 1 ) - c ) [ ( n - 2 ) ln ( n - 1 ) + c ] - & \\ ( ln n - c ) {( n - 1 )}^{2} {ln}^{2} ( n - 1 ) ] \geq 0. & \end{matrix}$$

The expansion of the left-hand side of (9) is as follows:
−cn²1n n 1n(n−1)+3cn 1n n 1n(n−1)−c²n 1n n−1n n 1n²(n−1)+cn²1n²(n−1)−2cn 1n²(n−1)+c 1n²(n−1)≧cn²1n(n−1)[1n(n−1)−1n n]+cn 1n n 1n(n−1)−c²n 1n n−1n n 1n²(n−1)+c 1n²(n−1)≧cn 1n(n−1)[1n n−2]−c²n 1n n−1n n 1n²(n−1).
Let c=3/4 ln no and let n₀ be the smallest integer such that
cn₀1n(n₀−1)[1n n₀−2−c²n₀1n n₀−1n n₀1n²(n₀−1)≧0.
By this definition, assertion (3) is true for n≦n₀ by assertion 2, and for n>n₀ by Equation (10).

From assertions 1 and 3,

$$\frac{4}{n} - \frac{4 c}{n ln n} \leq {α}_{n} \leq \frac{4}{n} .$$

This completes the proof of the lemma.

The simplest case of the Steiner tree packing problem for solution by the Steiner tree packing module 202 of FIG. 2 is where the number of requisite points is three (|S|=3). In such a scenario, Theorem 3 provides the following: Let G(V,E) be a graph and S be a subset of 3 vertices of G. If S is k-edge-connected in G, then there are

$$⌊ \frac{3}{4} k ⌋$$

edge-disjoint S-Steiner trees in G. The following example shows that the constant ¾ in the above corollary is not replaced with any larger constant.

Let G be a graph on s vertices with exactly r parallel edges between each pair of its vertices, and let S=V(G). Clearly, S is k-edge-connected, where k=(s−1)r. Since each S-Steiner tree has exactly s−1 edges, the maximum number of edge-disjoint S-Steiner trees in G is at most

$$r ( \begin{matrix}s \\ 2\end{matrix} ) / ( s - 1 ) = rs / 2 = \frac{s}{2 ( s - 1 )} k .$$

In particular, when s=3, the graph does not contain more than

$$\frac{3}{4} k$$

edge-disjoint Steiner trees.
An Exemplary Procedure

FIG. 5 shows an exemplary procedure 500 to locate a substantially maximum number of LED&P S-Steiner trees 206 (FIG. 2) that can be used in many practical applications to connect to a same set S of terminal vertices of a graph 204 (FIG. 2). For instance, with respect to data broadcasting (network data communication), a data broadcaster will typically desire to broadcast as many streams of data (e.g., movies) to end users (receivers) as possible. This is to substantially optimize data throughput and to provide end-users with a large number of data viewing options. If parallel edges are allowed, each link from the sender node to a receiver node may carry only one data stream. Parallel edges mean two edges between the same two nodes. If an edge has twice the capacity then a regular edge than that edge may be represented by two parallel edges. So we may assume that all the edges have the same capacity. In this scenario, to broadcast as many streams of data (e.g., movies) to end users (receivers) as substantially possible, the data broadcaster (sender) utilizes the Steiner tree packing module 202 of this exemplary procedure to analyze network node information 204 and produce/find a substantially maximum number of edge-disjoint Steiner trees 206 connecting the broadcaster to all users (receiver nodes). Subsequently, the broadcaster multicasts each data stream (e.g., of a movie) to the receiver(s) via the produced Steiner tree(s) 206.

In another example with respect to a VLSI implementation of the Steiner tree packing module 202, the packed Steiner tree(s) 206 are used to share an electric signal by a set of terminal nodes.

For purposes of discussion, the operations of procedure 500 are described in reference to the features of FIGS. 1 and 2. The left-most digit of a component reference number identifies the particular figure in which the component first appears. In this implementation, the procedure 500 generates LED&P S-Steiner trees 206 (FIG. 2) for multicast of streaming media from a broadcast terminal (network node) to one or more receiving terminals (network nodes). In this implementation, the computing device 130 (FIG. 1) represents a sender node (data broadcasting node), and respective implementations of the remote computing device 182 (FIG. 1) represent receiver and router (network switching, Steiner) nodes. Graph 204 is an undirected connected finite graph that provides sender, receiver, and router network node (vertex) input data. Data for streaming to the one or more receiver nodes is shown as a respective portion of “other data” 212.

At block 502, the Steiner tree packing module 202 (FIG. 2) analyzes the undirected graph 204 (input data) to produce a first Steiner tree 210 between two terminals, a sender and a receiver terminal. In this implementation, this is accomplished via Menger's theorem, which was described above. At block 504, the Steiner tree packing module 202 gets a next data point from the undirected finite graph 204. The data point, at this juncture, is a receiver node. An unprocessed data point is a data point that has not been connected to at least one of the Steiner tree(s) 210.

At block 506, the Steiner tree packing module 202 inductively grows the graph 204 with respect to this new data point. More specifically, the Steiner tree packing module 202 identifies one or more disjoint paths 208 from the new data point to the data terminals via any proceed Steiner nodes already connected to the processed nodes. At block 508, the Steiner tree packing module 202 determines if all data points in the graph 204 have been processed. If not, the procedure 500 continues at block 504 as described above. Otherwise, the procedure continues at block 510. At block 510, the Steiner tree packing module 202 merges the generated disjoint Steiner trees 210 with the disjoint paths 208 via the described shortcutting procedure while removing as many wasteful paths as substantially possible. This operation generates the LED&P Steiner trees 206.

For purposes of illustration, at block 512, the LED&P Steiner trees 206 are used by an application. For instance, the data broadcasting module of “Other Program Modules” 162 utilizes the LED&P Steiner trees 206 to substantially optimize its response to streaming data requesting network nodes. In this implementation, this is accomplished by multicasting streaming data to the set S of requesting terminals that are identified in at least one S-Steiner tree 206—the number of trees being selected by the application as a function of desired data throughput

Conclusion

The described systems and methods produce Steiner trees identifying a substantial maximum number of linked, edge-disjoint, and packed Steiner trees 206. Although the systems and methods have been described in language specific to structural features and methodological operations, the subject matter as defined in the appended claims are not necessarily limited to the specific features or operations described. For instance, although systems and methods of the invention have been described in reference to packing Steiner trees for multicast of streaming media, the systems and methods can also be utilized in other practical applications, such as in VLSI circuit design. Accordingly, the specific features and operations are disclosed as exemplary forms of implementing the claimed subject matter.

References

The following references [1] through [3] are hereby incorporated by reference.

[1] M. Kriesell. Local Spanning Tres in graphs and hypergraph decomposition with respect to edge connectivity. Technical Report 257, University of Hanover, 1999.

[2] A. Frank, T. Kiraly, and M. Kriesell. On decomposing a hypergraph into k-connected sub-hypergraphs. Technical report published by the Egreváry Research Group, Budapest, Hungary. ISSN 1587-4451, 2001.

[3] L. Petingi and J. Rodriguez. Bounds on the Maximum Number of Edge-disjoint Steiner Trees of a Graph. Congresus Numerantium, 145:43-52, 2000.

1. A method comprising:
generating a set of Steiner trees and paths from an undirected graph of vertices representing terminal and Steiner nodes; and
merging the Steiner trees and the paths to produce linked and edge-disjoint S-Steiner trees such that if a subset S of the vertices is k edge-connected, then there are α_{|S|}k edge-disjoint Steiner trees for S, where αₛ is at minimum a sequence that tends to an asymptotic approximation factor of |S|/4 as s tends to infinity.

2. A method as recited in claim 1, wherein generating further comprises analyzing an undirected graph of vertices representing terminal and Steiner nodes to produce a Steiner Tree between two terminal nodes of the terminal nodes, the two terminal nodes now being processed nodes.

3. A method as recited in claim 1, wherein generating further comprises:
for each unprocessed vertex of the vertices, identifying one or more respective paths from the unprocessed vertex to each of a set of processed terminal vertices of the vertices to inductively grow the undirected graph by creating the Steiner trees, the unprocessed vertex now being a processed vertex;
for each unprocessed vertex of the vertices, identifying one or more respective paths from the unprocessed vertex to each of a set of processed terminal vertices of the vertices to inductively grow the undirected graph by creating the Steiner trees, the unprocessed vertex now being a processed vertex; and
for each Steiner tree:
determining if a path of the paths shares an edge with the Steiner tree; and
responsive to determining that the path shares the edge, shortcutting the path to a vertex of the Steiner tree by removing a portion of the path that is subsequent to the edge, each Steiner tree being used to shortcut a path of the paths being a path-tree.

4. A method as recited in claim 1, wherein the vertices represent respective sending, receiving, and router network nodes, and wherein the method further comprises:
receiving a set of requests for streaming data from at least a subset of vertices of S, the at least a subset representing receiving network nodes;
identifying one or more of the edge-disjoint Steiner trees that comprise each of the at least a subset; and
multicasting the streaming data to the at least a subset over communication pathways identified by the one or more of the edge-disjoint Steiner trees.

5. A method as recited in claim 1, wherein the substantially α_{|S|}k edge-disjoint Steiner trees for S are at minimum the following:
$${SOL}_{p} ( x ) = {x}_{0} + {x}_{p} - ⌈ ( {x}_{0} - {\sum }_{i = p + 1}^{s} {ix}_{i} ) / p ⌉ + {\sum }_{i = 1}^{p - 1} {x}_{i} \\ = ⌊ \frac{p - 1}{p} {x}_{0} + {\sum }_{i = 1}^{p} {x}_{i} + {\sum }_{i = p + 1}^{s} \frac{i}{p} {x}_{i} ⌋ ,$$
wherein x₀ represents the Steiner trees not used to shortcut any path, x₀ represents Steiner trees used to shortcut a path,

6. A method as recited in claim 5, wherein p is a number such that Σᵢ₌ₚ₊₁^{s}ixᵢ<x₀≦Σᵢ₋ₚ₊₁^{s}ixᵢ.

7. A method as recited in claim 5, wherein if x₀≦sxₛ, p=s.

8. A method as recited in claim 5, wherein if Σᵢ₌₁^{s}ixᵢ<x₀, p=0.

9. A computer-readable medium comprising computer-executable instructions for packing Steiner trees, the computer-executable instructions comprising instructions for:
generating a set of Steiner trees and paths from an undirected graph of vertices representing terminal and Steiner nodes; and
merging the Steiner trees and the paths to produce linked and edge-disjoint S-Steiner trees such that if a subset S of the vertices is k edge-connected, then at minimum there are α_{|S|}k edge-disjoint Steiner trees for S, where αₛ is a sequence that tends to an asymptotic approximation factor of |S|/4 as s tends to infinity.

10. A computer-readable medium as recited in claim 9, wherein the computer-executable instructions for generating further comprise instructions for analyzing an undirected graph of vertices representing terminal and Steiner nodes to produce a Steiner Tree between two terminal nodes of the terminal nodes, the two terminal nodes now being processed nodes.

11. A computer-readable medium as recited in claim 9, wherein the computer-executable instructions for generating further comprise instructions for:
for each unprocessed vertex of the vertices, identifying one or more respective paths from the unprocessed vertex to each of a set of processed terminal vertices of the vertices to inductively grow the undirected graph by creating the Steiner trees, the unprocessed vertex now being a processed vertex;
for each unprocessed vertex of the vertices, identifying one or more respective paths from the unprocessed vertex to each of a set of processed terminal vertices of the vertices to inductively grow the undirected graph by creating the Steiner trees, the unprocessed vertex now being a processed vertex; and
for each Steiner tree:
determining if a path of the paths shares an edge with the Steiner tree; and
responsive to determining that the path shares the edge, shortcutting the path to a vertex of the Steiner tree by removing a portion of the path that is subsequent to the edge, each Steiner tree being used to shortcut a path of the paths being a path-tree.

12. A computer-readable medium as recited in claim 9, wherein the vertices represent respective sending, receiving, and router network nodes, and wherein the computer-executable instructions further comprise instructions for:
receiving a set of requests for streaming data from at least a subset of vertices of S, the at least a subset representing receiving network nodes;
identifying one or more of the edge-disjoint Steiner trees that comprise each of the at least a subset; and
multicasting the streaming data to the at least a subset over communication pathways identified by the one or more of the edge-disjoint Steiner trees.

13. A computer-readable medium as recited in claim 9, wherein the α_{|S|}k edge-disjoint Steiner trees for S are at minimum based on the following:
$${SOL}_{p} ( x ) = {x}_{0} + {x}_{p} - ⌈ ( {x}_{0} - {\sum }_{i = p + 1}^{s} {ix}_{i} ) / p ⌉ + {\sum }_{i = 1}^{p - 1} {x}_{i} \\ = ⌊ \frac{p - 1}{p} {x}_{0} + {\sum }_{i = 1}^{p} {x}_{i} + {\sum }_{i = p + 1}^{s} \frac{i}{p} {x}_{i} ⌋ ,$$
wherein x₀ represents the Steiner trees not used to shortcut any path, x₀ represents Steiner trees used to shortcut a path.

14. A computer-readable medium as recited in claim 13, wherein p is a number such that Σᵢ₌ₚ₊₁^{s}ixᵢ<x₀≦Σᵢ₋ₚ₊₁^{s}ixᵢ.

15. A computer-readable medium as recited in claim 9, wherein if x₀≦sxₛ, p=s.

16. A computer-readable medium as recited in claim 9, wherein if Σᵢ₌₁^{s}ixᵢ<x₀, p=0.

17. A computing device comprising:
a processor;
a memory coupled to the processor, the memory comprising computer instructions executable by the processor for:
generating a set of Steiner trees and paths from an undirected graph of vertices representing terminal and Steiner nodes; and
merging the Steiner trees and the paths to produce linked and edge-disjoint S-Steiner trees such that if a subset S of the vertices is k edge-connected, then at minimum there are α_{|S|}k edge-disjoint Steiner trees for S, where αₛ is a sequence that tends to an asymptotic approximation factor of |S|/4 as s tends to infinity.

18. A computing device as recited in claim 17, wherein the computer instructions for generating further comprise instructions for analyzing an undirected graph of vertices representing terminal and Steiner nodes to produce a Steiner Tree between two terminal nodes of the terminal nodes, the two terminal nodes now being processed nodes.

19. A computing device as recited in claim 17, wherein the computer instructions for generating further comprise instructions for:
for each unprocessed vertex of the vertices, identifying one or more respective paths from the unprocessed vertex to each of a set of processed terminal vertices of the vertices to inductively grow the undirected graph by creating the Steiner trees, the unprocessed vertex now being a processed vertex;
for each unprocessed vertex of the vertices, identifying one or more respective paths from the unprocessed vertex to each of a set of processed terminal vertices of the vertices to inductively grow the undirected graph by creating the Steiner trees, the unprocessed vertex now being a processed vertex; and
for each Steiner tree:
determining if a path of the paths shares an edge with the Steiner tree; and
responsive to determining that the path shares the edge, shortcutting the path to a vertex of the Steiner tree by removing a portion of the path that is subsequent to the edge, each Steiner tree being used to shortcut a path of the paths being a path-tree.

20. A computing device as recited in claim 17, wherein the vertices represent respective sending, receiving, and router network nodes, and wherein the computer-executable instructions further comprise instructions for:
receiving a set of requests for streaming data from at least a subset of vertices of S, the at least a subset representing receiving network nodes;
identifying one or more of the edge-disjoint Steiner trees that comprise each of the at least a subset; and
multicasting the streaming data to the at least a subset over communication pathways identified by the one or more of the edge-disjoint Steiner trees.

21. A computing device as recited in claim 17, wherein the α_{|S|}k edge-disjoint Steiner trees for S are at minimum based on the following:
$${SOL}_{p} ( x ) = {x}_{0} + {x}_{p} - ⌈ ( {x}_{0} - {\sum }_{i = p + 1}^{s} {ix}_{i} ) / p ⌉ + {\sum }_{i = 1}^{p - 1} {x}_{i} \\ = ⌊ \frac{p - 1}{p} {x}_{0} + {\sum }_{i = 1}^{p} {x}_{i} + {\sum }_{i = p + 1}^{s} \frac{i}{p} {x}_{i} ⌋ ,$$
wherein x₀ represents the Steiner trees not used to shortcut any path, x₀ represents Steiner trees used to shortcut a path,

22. A computing device as recited in claim 21, wherein p is a number such that Σᵢ₌ₚ₊₁^{s}ixᵢ<x₀≦Σᵢ₋ₚ₊₁^{s}ixᵢ.

23. A computing device as recited in claim 21, wherein if x₀≦sxₛ, p=s.

24. A computing device as recited in claim 21, wherein if Σᵢ₌₁^{s}ixᵢ<x₀, p=0.

25. A computing device comprising:
means for generating a set of Steiner trees and paths from an undirected graph of vertices representing terminal and Steiner nodes; and
means for merging the Steiner trees and the paths to produce linked and edge-disjoint S-Steiner trees such that if a subset S of the vertices is k edge-connected, then at minimum there are substantially α_{|S|}k edge-disjoint Steiner trees for S , where αₛ is a sequence that tends to an asymptotic approximation factor of |S|/4 as s tends to infinity.

26. A computing device as recited in claim 25, wherein the means for generating further comprise means for analyzing an undirected graph of vertices representing terminal and Steiner nodes to produce a Steiner Tree between two terminal nodes of the terminal nodes, the two terminal nodes now being processed nodes.

27. A computing device as recited in claim 25, wherein the means for generating further comprise:
means for each unprocessed vertex of the vertices, identifying one or more respective paths from the unprocessed vertex to each of a set of processed terminal vertices of the vertices to inductively grow the undirected graph by creating the Steiner trees, the unprocessed vertex now being a processed vertex;
for each unprocessed vertex of the vertices, means for identifying one or more respective paths from the unprocessed vertex to each of a set of processed terminal vertices of the vertices to inductively grow the undirected graph by creating the Steiner trees, the unprocessed vertex now being a processed vertex; and
for each Steiner tree:
means for determining if a path of the paths shares an edge with the Steiner tree; and
responsive to determining that the path shares the edge, means for shortcutting the path to a vertex of the Steiner tree by removing a portion of the path that is subsequent to the edge, each Steiner tree being used to shortcut a path of the paths being a path-tree.

28. A computing device as recited in claim 25, wherein the vertices represent respective sending, receiving, and router network nodes, and further comprising:
means for receiving a set of requests for streaming data from at least a subset of vertices of S, the at least a subset representing receiving network nodes;
means for identifying one or more of the edge-disjoint Steiner trees that comprise each of the at least a subset; and
means for multicasting the streaming data to the at least a subset over communication pathways identified by the one or more of the edge-disjoint Steiner trees
